(19) United States
(12) Patent Application Publication
(10) Pub. No.: US 2016/0181591 A1
(43) Pub. Date: Jun. 23, 2016

(54) METHOD OF MANUFACTURING LITHIUM ION SECONDARY BATTERY

(71) Applicant: TOYOTA JIDOSHA KABUSHIKI KAISHA, Toyota-shi (JP)

(72) Inventor: Koji TAKAHATA, Nisshin-shi (JP)

(73) Assignee: TOYOTA JIDOSHA KABUSHIKI KAISHA, Toyota-shi (JP)

(21) Appl. No.: 14/974,614

(22) Filed: Dec. 18, 2015

(30) Foreign Application Priority Data
Dec. 23, 2014 (JP) 2014-259619

(51) Int. Cl. H01M 2/36; H01M 10/0568; H01M 4/62; H01M 10/0525

(52) U.S. Cl. CPC H01M 2/362; H01M 10/0525; H01M 10/0568; H01M 4/622

(57) ABSTRACT

Provided is a method of manufacturing a lithium ion secondary battery in which a battery system contains Na, the lithium ion secondary battery including a battery case which accommodates a positive electrode, a negative electrode, and a nonaqueous electrolytic solution containing LiBOB. This method includes: a pressure reduction step of reducing an internal pressure of the battery case; and a liquid injection step of injecting the nonaqueous electrolytic solution after the pressure reduction step.

### INCORPORATION BY REFERENCE

The disclosure of Japanese Patent Application No. 2014-259619 filed on Dec. 23, 2014 including the specification, drawings and abstract is incorporated herein by reference in its entirety.

### BACKGROUND OF THE INVENTION

1. Field of the Invention

The present invention relates to a method of manufacturing a lithium ion secondary battery.

2. Description of Related Art

One of the secondary batteries is a lithium ion secondary battery. The lithium ion secondary battery includes: positive and negative electrodes capable of reversibly storing and releasing lithium ions; and a separator that is interposed between the positive and negative electrodes. Recently, a secondary battery such as a lithium ion secondary battery has been used as a motor-driving power supply or an auxiliary power supply for an electric vehicle, a hybrid electric vehicle, or a fuel cell vehicle.

As a method of manufacturing a lithium ion secondary battery, various methods have been disclosed. For example, Japanese Patent Application Publication No. 2013-097980 (JP 2013-097980 A) discloses a method of reducing the internal pressure of a battery case in order to make an electrolytic solution spread over the entire area of an electrode body after injection of the electrolytic solution. Japanese Patent Application Publication No. 2014-154279 (JP 2014-154279 A) discloses a nonaqueous electrolyte secondary battery in which styrene-butadiene rubber (SBR) is used as a binder of a negative electrode, and lithium bis(oxalato)borate (LiBOB) is added to a nonaqueous electrolytic solution.

The charging-discharging of a lithium ion secondary battery is controlled by determining maximum current value in order to suppress lithium deposition and to obtain the maximum battery output. Lithium deposition needs to be minimized because it causes deterioration in, for example, the capacity or output of a battery. Therefore, the maximum current value is desirably a value corresponding to a limit current value which is determined based on the resistance value of a battery. The limit current value is a current value at which lithium deposition is started.

The technique disclosed in JP 2014-154279 A relates to a nonaqueous electrolyte secondary battery in which superior battery characteristics are realized. In many cases, the battery system of a nonaqueous electrolyte secondary battery such as a lithium ion secondary battery contains a large amount of sodium (Na) which is an impurity. In this case, when LiBOB is used as an additive of an electrolytic solution, LiBOB and Na react with each other, and a reactant between LiBOB and Na precipitates. At this time, the electrolytic solution is impregnated into both ends of an electrode body. Therefore, LiBOB precipitates on the end portions of the electrode body, and LiBOB is likely to be lean at the center of the electrode body. Therefore, the resistance value at the center of the electrode body is likely to increase. Accordingly, the limit current value is dependent on the resistance value at the center of the electrode body. In the technique disclosed in JP 2013-097980 A, the internal pressure of a battery case is reduced in order to make an electrolytic solution spread over the entire area of an electrode body after injection of the electrolytic solution. However, in the above-described method of injecting an electrolytic solution, the LiBOB distribution in the electrode body of the obtained battery is not stable, and the resistance value at the center of the electrode body is unstable as described above. As a result, the resistance value varies depending on each battery, and there is a variation in limit current value. Accordingly, a gap is generated between the limit current value and the maximum current value. The reason for this is presumed to be that, due to a reduction in pressure after the injection (a reduction in pressure in a state where half of the electrode body is soaked in the electrolytic solution), the electrolytic solution is not impregnated into both ends of the electrode body and does not spread over the entire region of the electrode body. Specifically, when the limit current value is higher than the maximum current value, the battery performance cannot be maximized, and the maximum output of the battery cannot be obtained. Conversely, when the limit current value is lower than the maximum current value, the current value exceeds the limit current value, and thus lithium deposition may not be suppressed.

### SUMMARY OF THE INVENTION

The invention provides a method of manufacturing a lithium ion secondary battery in which a nonaqueous electrolytic solution contains LiBOB, the method capable of reducing a variation in resistance value and making battery characteristics uniform.

A method of manufacturing a lithium ion secondary battery according to the invention has the following configurations. In the method of manufacturing a lithium ion secondary battery, a battery system contains sodium (Na), the lithium ion secondary battery includes a battery case which accommodates an electrode body and a nonaqueous electrolytic solution, the electrode body includes a positive electrode and a negative electrode, the positive electrode includes a positive electrode active material layer containing a positive electrode active material, the negative electrode includes a negative electrode active material layer containing a negative electrode active material, and the nonaqueous electrolytic solution contains lithium bis(oxalato)borate. This method includes reducing an internal pressure of the battery case; and injecting the nonaqueous electrolytic solution after the reduction in the internal pressure.

According to this method, the nonaqueous electrolytic solution is injected after the reduction in the internal pressure of the battery case. Therefore, the nonaqueous electrolytic solution is impregnated into both ends of the electrode body and can spread over the entire region of the electrode body. Thus, the resistance value at the center of the electrode body can be increased, and battery characteristics can be stabilized. Specifically, the limit current value can be stabilized. Due to the above-described configuration, even in a lithium ion secondary battery in which a battery system contains Na and in which LiBOB is added to the nonaqueous electrolytic solution, a variation in resistance value can be reduced, and battery characteristics can be made to be uniform. As a result, safety and performance as a battery can be secured.

According to an aspect of the method disclosed herein, the negative electrode may contain styrene-butadiene rubber (SBR) as a binder.

SBR contains a large amount of Na and is highly reactive with LiBOB. Therefore, the resistance at the center of the electrode body is likely to increase. As a result, a lithium ion secondary battery having reduced variation in resistance value and uniform battery characteristics can be manufactured. According to another aspect of the method disclosed herein, in the positive electrode active material, a full width at half maximum β of a diffraction peak of a (003) plane may satisfy 0.055≦β≦0.097. Unless specified otherwise, “the full width at half maximum β of a diffraction peak of a (003) plane” refers to a full width at half maximum obtained from X-ray diffraction.

In the positive electrode active material, crystallinity is optimized. Thus, the resistance value at the center of the electrode body is stable, and battery characteristics can be stabilized. For example, when the full width at half maximum β is 0.055 or lower and crystallinity is low, a layered structure is disordered. Therefore, metal is likely to be eluted from a positive electrode, and the resistance value is likely to increase. Thus, the resistance value varies depending on each battery, and a lithium ion secondary battery having uniform battery characteristics cannot be obtained. On the other hand, for example, when the full width at half maximum β is 0.097 or higher and crystallinity is high, the resistance value increases, and the resistance value is likely to vary depending on each battery. The reason for this is presumed to be that, the conductivity of the positive electrode active material is reduced due to high crystallinity, and contact between a conductive material and the positive electrode active material is not likely to occur. According to still another aspect of the method disclosed herein, during the reduction in the internal pressure, a vacuum degree may be 1 kPa·abs to 40 kPa·abs. Since the vacuum degree as a pressure reduction condition is adjusted to be within the above-described range, the electrolytic solution is impregnated into both ends of the electrode body and can spread over the entire region of the electrode body. Thus, the resistance value at the center of the electrode body can be increased, and battery characteristics can be stabilized. For example, when the vacuum degree is 1 kPa·abs or lower, the internal pressure of the battery system is excessively low, and the electrolytic solution is boiled. On the other hand, for example, when the vacuum degree is 40 kPa·abs or higher, pressure reduction is insufficient. Therefore, the electrolytic solution cannot spread over the entire region of the electrode body, and battery characteristics cannot be stabilized.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view schematically showing the external appearance of a lithium ion secondary battery according to an embodiment of the invention;

FIG. 2 is a longitudinal sectional view schematically showing a sectional structure taken along line II-II of FIG. 1;

FIG. 3 is a flowchart showing an example of steps of manufacturing the lithium ion secondary battery according to the embodiment of the invention;

FIG. 4 is Table 1 showing the results (limit current values) of Examples 1 to 4 in a durability test; and

FIG. 5 is Table 2 showing the results (limit current values) of Examples 5 to 8 in a durability test.

### DETAILED DESCRIPTION OF EMBODIMENTS

Preferred embodiments of the invention are described below. Matters necessary to implement the embodiments of the invention other than those specifically referred to in this description may be understood as design matters based on the related art in the pertinent field for a person of ordinary skill in the art. The invention can be practiced based on the contents disclosed in this specification and common technical knowledge in the pertinent field.

In the following drawings, parts or portions having the same function are represented by the same reference numerals, and repeated descriptions will not be made or will be simplified. In each drawing, a dimensional relationship (for example, length, width, or thickness) does not reflect the actual dimensional relationship.

Hereinafter, a lithium ion secondary battery 100 (hereinafter, also referred to simply as “battery”) according to a preferred embodiment of the invention will be described.

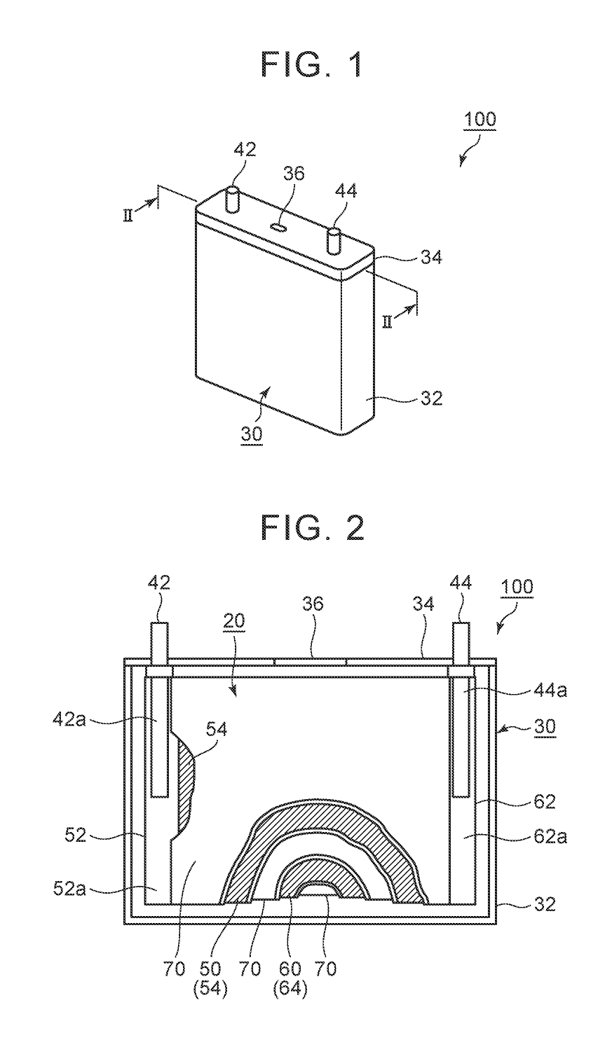

FIG. 1 is a diagram showing the external appearance of the battery (cell) 100 according to the embodiment. FIG. 2 is a sectional view schematically showing an internal structure of a battery case 30 according to the embodiment.

As shown in FIGS. 1 and 2, the lithium ion secondary battery 100 according to the embodiment is, in a broad sense, a so-called square battery 100 having a configuration in which a flat wound electrode body 20 and a nonaqueous electrolyte (not shown) are accommodated in a flat square battery case (that is, an external case) 30. The battery case 30 includes: a box-shaped (that is, a bottomed rectangular parallelepiped-shaped) case body 32 having an opening at an end (corresponding to an upper end in a normal operating state of the battery); and a lid 34 that seals the opening of the case body 32. As the material of the battery case 30, for example, a light-weight and highly thermally conductive metal material such as aluminum, stainless steel, or nickel-plated steel may be preferably used.

As shown in FIGS. 1 and 2, a positive electrode terminal 42 and a negative electrode terminal 44 for external connection, a thin safety valve 36, and an injection hole (not shown) for the injection of a nonaqueous electrolyte (nonaqueous electrolytic solution) are provided on the lid 34. The safety valve 36 is set to release an internal pressure of the battery case 30 when the internal pressure increases to be a predetermined level or higher. The battery case 30 of the lithium ion secondary battery 100 may have other well-known shapes in addition to the square shape (box shape) as shown in the drawing. Examples of the other well-known shapes include a cylindrical type, a coin type, and a laminate type. Among these, an appropriate case shape can be selected.

As shown in FIG. 2, the wound electrode body 20 accommodated in the battery case 30 is formed in a flat shape in which a laminate is wound in a longitudinal direction. In the laminate, a positive electrode 50 and a negative electrode 60 are laminated with two elongated separators 70 interposed therebetween. In the positive electrode 50, a positive electrode active material layer 54 is formed on a single surface or both surfaces (herein, both surfaces) of an elongated positive electrode current collector 52 in the longitudinal direction. In the negative electrode 60, a negative electrode active material layer 64 is formed on a single surface or both surfaces (herein, both surfaces) of an elongated negative electrode current collector 62 in the longitudinal direction. In addition, the flat wound electrode body 20 is formed in a flat shape, for example, by winding the laminate to obtain a wound body and squashing the wound body from the side surface thereof. The positive electrode current collector 52 constituting the positive electrode 50 is formed of, for example, aluminum foil. On the other hand, the negative electrode current collector 62 constituting the negative electrode 60 is formed of, for example, copper foil.

As shown in FIG. 2, a winding core portion (that is, the laminate structure in which the positive electrode active material layer 54 of the positive electrode 50, the negative electrode active material layer 64 of the negative electrode 60, and the separators 70 are laminated) is formed in the center of the wound electrode body 20 in a winding axial direction. In addition, at opposite end portions of the wound electrode body 20 in the winding axial direction, a part of a positive electrode active material layer non-forming portion 52a and a negative electrode active material layer non-forming portion 62a protrude from the winding core portion to the outside, respectively. A positive electrode current collector plate 42a is attached to the protrusion on the positive electrode side (the positive electrode active material layer non-forming portion 52a). A negative electrode current collector plate 44a is attached to the protrusion on the negative electrode side (the negative electrode active material layer non-forming portion 62a). The positive electrode current collector plate 42a and the negative electrode current collector plate 44a are electrically connected to the positive electrode terminal 42 and the negative electrode terminal 44, respectively.

The positive electrode active material layer 54 according to the embodiment contains a positive electrode active material as a major component.

As the positive electrode active material, one material or two or more materials selected from materials which are used for a lithium ion secondary battery in the related art may be used without any particular limitation. Examples of the positive electrode active material include oxides (lithium transition metal composite oxides) containing lithium and a transition metal element as constituent metal elements, such as lithium nickel composite oxide (for example, LiNiO₂), lithium cobalt composite oxide (for example, LiCoO₂), and lithium manganese composite oxide (for example, LiMn₂O₄); and phosphates containing lithium and a transition metal element as constituent metal elements, such as lithium manganese phosphate (LiMnPO₄) and lithium iron phosphate (LiFePO₄).

The positive electrode active material is not particularly limited, but, for example, a lithium transition metal composite oxide powder which is substantially formed of secondary particles having a particle size of 1 μm to 25 μm (typically, 2 μm to 10 μm; for example, 6 μm to 10 μm) can be preferably used as the positive electrode active material, in which the particle size corresponds to a cumulative value of 50% (median size: D50) in a volume particle size distribution obtained using a general laser diffraction particle size distribution analyzer. In this specification, unless specified otherwise, “particle size” refers to a median size in a volume particle size distribution obtained using a general laser diffraction particle size distribution analyzer.

The positive electrode active material layer 54 may further contain components other than the positive electrode active material as the above-described major component, for example, a conductive material or a binder. As the conductive material, for example, a carbon material such as carbon black (for example, acetylene black (AB)) or graphite may be preferably used. As the binder, for example, polyvinylidene fluoride (PVdF) may be used.

The negative electrode active material layer 64 contains at least a negative electrode active material. As the negative electrode active material, for example, a carbon material such as graphite, hard carbon, or soft carbon may be used. The negative electrode active material layer 64 may further contain components other than the active material, for example, a binder or a thickener. As the binder, for example, styrene-butadiene rubber (SBR) may be used. As the thickener, for example, carboxymethyl cellulose (CMC) may be used.

Examples of the separator 70 include a porous sheet (film) formed of a resin such as polyethylene (PE), polypropylene (PP), polyester, cellulose, or polyamide. The porous sheet may have a single-layer structure or a laminate structure including two or more layers (for example, a three-layer structure in which a PE layer is laminated on both surfaces of a PP layer).

In the nonaqueous electrolytic solution, typically, an organic solvent (nonaqueous solvent) may contain a predetermined supporting electrolyte and predetermined additives.

As the nonaqueous solvent, various organic solvents which can be used in an electrolyte of a general lithium ion secondary battery 100, for example, carbonates, ethers, esters, nitriles, sulfones, and lactones can be used without any limitation. Specific examples of the nonaqueous solvent include ethylene carbonate (EC), propylene carbonate (PC), diethyl carbonate (DEC), dimethyl carbonate (DMC), and ethyl methyl carbonate (EMC). Among these nonaqueous solvents, one kind can be used alone, or two or more kinds can be appropriately used in combination.

Alternatively, fluorine-based solvents, for example, fluorinated carbonates such as monofluoroethylene carbonate (MFEC), difluoroethylene carbonate (DFEC), and trifluoro dimethyl carbonate (TFDMC) can be preferably used. For example, a mixed solvent containing MFEC and TFDMC at a volume ratio of 1:2 to 2:1 (for example, 1:1) has high oxidation resistance and thus can be preferably used in combination with a high-potential electrode.

As the supporting electrolyte, for example, a lithium salt such as LiPF₆, LiBF₄, or LiClO₄ can be preferably used. Among these supporting electrolytes, for example, LiPF₆ is particularly preferably used. The concentration of the supporting electrolyte is preferably 0.7 mol/L to 1.3 mol/L and is more preferably about 1.0 mol/L.

The nonaqueous electrolyte may further contain optional components other than the nonaqueous solvent and the supporting electrolyte within a range where the effects of the invention do not deteriorate. These optional components are used for one or two or more of the purposes including: improvement of battery output performance; improvement of storability (prevention of a decrease in capacity during storage); and improvement of initial charge-discharge efficiency. Examples of the optional components other than LiBOB include a gas producing agent such as biphenyl (BP) or cyclohexylbenzene (CHB); and various additives, for example, a film forming agent such as an oxalato complex compound containing a boron atom and/or a phosphorus atom, vinylene carbonate (VC), or fluoroethylene carbonate (FEC), a dispersant, and a thickener.

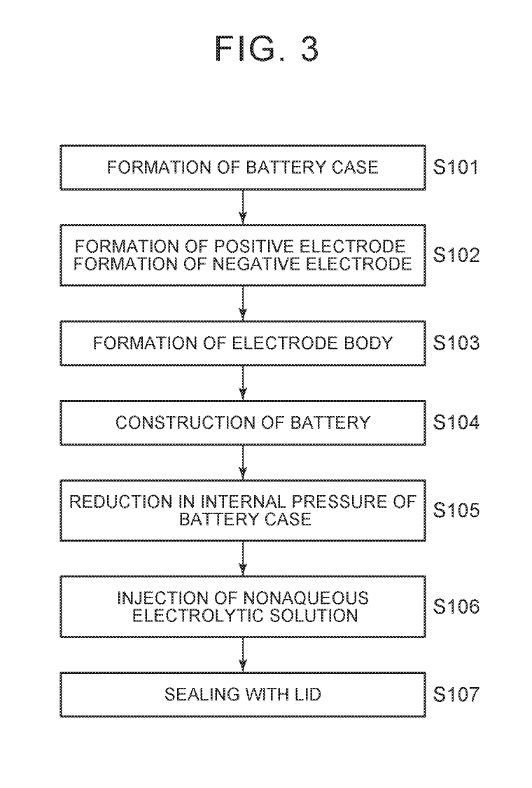

Next, a method of manufacturing the lithium ion secondary battery 100 according to the embodiment will be described. FIG. 3 is a flowchart schematically showing an example of steps of manufacturing the lithium ion secondary battery 100 according to the embodiment. The manufacturing process of the lithium ion secondary battery 100 starts from a step of preparing the battery case 30 (S101). This step is equivalent to the step of manufacturing the battery case 30.

Next, the process proceeds to a step of preparing the positive electrode 50 and the negative electrode 60 which constitute the electrode body (S102). The manufacturing step S102 will be described below in detail.

First, the positive electrode 50 will be described. The above-described positive electrode active material (for example, LiNi_{0.5}Mn_{1.5}O₄ which is the high-potential positive electrode active material), and other optional materials (for example, the binder and the conductive material) are dispersed in an appropriate solvent (when PVdF is used as the binder, N-methyl-2-pyrrolidone (NMP) is preferable) to prepare a paste (slurry) composition. Next, an appropriate amount of the composition is applied to a surface of the positive electrode current collector 52 and then is dried to remove the solvent. As a result, the positive electrode active material layer 54 having desired characteristics can be formed on the positive electrode current collector 52, and thus the positive electrode 50 can be formed. In addition, by optionally performing an appropriate pressing treatment, the characteristics (for example, the average thickness, the active material density, or the porosity of the active material layer) of the positive electrode active material layer 54 can be adjusted.

Next, the negative electrode 60 will be described. The negative electrode 60 can be manufactured, for example, using the same method as in the positive electrode 50. That is, the negative electrode active material and other optional materials are dispersed in an appropriate solvent (for example, ion exchange water) to prepare a paste-like (slurry-like) composition. Next, an appropriate amount of the composition is applied to a surface of the negative electrode current collector 62 and then is dried to remove the solvent. As a result, the negative electrode can be formed. In addition, by optionally performing an appropriate pressing treatment, the characteristics (for example, the average thickness, the active material density, or the porosity of the active material layer) of the negative electrode active material layer 64 can be adjusted.

Referring to the manufacturing steps of FIG. 3 again, after the formation of the positive electrode 50 and the negative electrode 60 (S102), the process proceeds to a step of forming the electrode body (S103). Here, the electrode body is formed using the positive electrode 50, the negative electrode 60, and the separator 70 described above. For example, the positive electrode 50 and the negative electrode 60 are laminated with the separator 70 interposed therebetween to obtain a laminate, and the laminate is wound. As a result, the wound electrode body 20 is formed.

After the formation of the electrode body (S103), the process proceeds to a step of constructing the battery (S104). Here, the battery is constructed using the battery case 30 and the electrode body (for example, the wound electrode body 20) described above. The wound electrode body 20 is accommodated in the battery case 30 to construct the lithium ion secondary battery 100. After the construction of the battery, the process proceeds to a step of reducing the internal pressure of the battery case 30 (S105). Next, after the reduction in the internal pressure, the process proceeds to a step of injecting the nonaqueous electrolytic solution in a state where the battery case 30 is sealed (S106). After completion of the injection, the process proceeds to a step of sealing the battery case 30 with the lid 34 (S107). In the pressure reduction step (S105), the internal pressure of the battery case 30 is reduced by providing the battery case 30 in a large closed space and reducing the internal pressure of the closed space. At this time, a vacuum degree as a pressure reduction condition is 1 kPa·abs to 40 kPa·abs. The lower limit of the vacuum degree is very close to 0; however, when the vacuum degree is lower than 1 kPa·abs, the internal pressure of the battery system is excessively low, and the electrolytic solution is boiled. The minimum vacuum degree is 40 kPa·abs or lower. When the vacuum degree is 40 kPa·abs or higher, pressure reduction is insufficient. Therefore, the electrolytic solution cannot spread over the entire region of the electrode body, and battery characteristics cannot be stabilized. The vacuum degree is more preferably 25 kPa·abs or lower and still more preferably 15 kPa·abs or lower. In the liquid injection step (S106), in a state where the internal pressure of the battery case 30 is reduced in the pressure reduction step (S105), a nonaqueous electrolytic solution containing LiBOB is injected into the battery case 30 using a liquid injecting device provided inside the closed space. Next, the pressure-reduced state is released, and the battery case 30 is sealed with the lid 34. As a result, a square battery is constructed.

As described above, all the operations after the pressure reduction step (S105) are performed in the closed space. Therefore, the nonaqueous electrolytic solution is impregnated into both ends of the electrode body and can spread over the entire region of the electrode body. Thus, the resistance value at the center of the electrode body can be increased, and battery characteristics can be stabilized. The reduction in the internal pressure and the liquid injection can be performed using a method other than the above-described method. Specifically, a method may be adopted including: bringing a container, which is filled with the electrolytic solution, into contact with a liquid injection hole of the constructed battery cell; and reducing the internal pressure of the container.

In the above-described method of manufacturing the lithium ion secondary battery 100 according to the embodiment, the nonaqueous electrolytic solution is injected after the reduction in the internal pressure of the battery case 30. Therefore, the nonaqueous electrolytic solution can spread over the entire region of the electrode body. Thus, the resistance value at the center of the electrode body can be increased, and battery characteristics can be stabilized. Even in the lithium ion secondary battery 100 in which SBR is used as the binder of the negative electrode and in which LiBOB is added to the nonaqueous electrolytic solution, a variation in resistance value can be reduced, and battery characteristics can be made to be uniform. Accordingly, in the lithium ion secondary battery 100, safety and reliability as a battery can be secured.

In the method of manufacturing the lithium ion secondary battery 100 according to the embodiment, the electrode body is formed after the formation of the battery case. However, the battery case may be formed after the formation of the electrode body. That is, the manufacturing steps S102 and S103 may be performed before the manufacturing step S101.

The lithium ion secondary battery 100 disclosed herein can be used in various applications. For example, the lithium ion secondary battery 100 can be preferably used as a driving power supply mounted in a vehicle such as a plug-in hybrid vehicle (PHV), a hybrid vehicle (HV), or an electric vehicle (EV).

Hereinafter, test examples relating to the invention will be described. However, the descriptions of these test examples are not intended to limit the technical scope of the invention.

### Example 1

In order to prepare a positive electrode mixture, a layered positive electrode active material, acetylene black (conductive material), and PVdF (binder) were mixed with each other such that a weight ratio thereof was 89:8:3. The obtained mixture was dissolved in NMP as a solvent to prepare a slurry composition. The layered positive electrode active material used herein was LiNi_{0.5}Mn_{1.5}O₄ and had an average particle size of 13 μm. This positive electrode mixture slurry was applied to aluminum foil (positive electrode current collector) having a thickness of 15 μm, was dried to form a positive electrode active material layer thereon, and was roll-pressed. As a result, a positive electrode was manufactured.

In order to prepare a negative electrode mixture, graphite (negative electrode active material; average particle size: 20 μm, graphitization degree≧0.9), CMC (thickener), and SBR (binder) were mixed with each other such that a weight ratio thereof was 98:1:1. The obtained mixture was dissolved in water as a solvent to prepare a slurry. This negative electrode mixture slurry was applied to copper foil (negative electrode current collector) having a thickness of 10 μm, was dried to form a negative electrode active material layer thereon, and was roll-pressed. As a result, a negative electrode was manufactured.

LiBOB as an additive was added to a mixed solvent containing EC, EMC, and DMC at a volume ratio of 3:4:3 to prepare a nonaqueous electrolytic solution. The content of LiBOB was adjusted to be 1 wt % with respect to 100 wt % of the content of the negative electrode active material.

A separator (porous PE/PP/PE three-layer sheet) having an appropriate size was cut out and was impregnated with the nonaqueous electrolytic solution. The positive electrode and the negative electrode were laminated with the separator interposed therebetween to obtain a laminate, and this laminate was wound. As a result, an electrode body was formed. The electrode body was accommodated in the battery case, the internal pressure of a battery case was reduced, the nonaqueous electrolytic solution was injected into the battery case, and the battery case was sealed with a lid. As a result, a square battery was constructed. During the reduction in the internal pressure, the vacuum degree was 10 kPa·abs.

### Example 2

A square battery was constructed using the same method as in Example 1, except that the internal pressure of the battery case was reduced after the injection of the nonaqueous electrolytic solution.

### Example 3

A square battery was constructed using the same method as in Example 1, except that no additives including LiBOB were used.

### Example 4

A square battery was constructed using the same method as in Example 1, except that: the internal pressure of the battery case was reduced after the injection of the nonaqueous electrolytic solution; and no additives including LiBOB were used.

### [Conditioning Treatment]

The state of charge (SOC) of each of the battery cells according to Examples 1 to 4 was adjusted to 80%, and the battery cell was stored at an environmental temperature of 60° C. for 3 days.

### [Durability Test]

After the conditioning treatment, a durability test was performed on each of the battery cells according to the examples using two methods which were different from each other regarding whether or not an additive was added. The details will be described below. In the two tests, the limit current value was determined by calculating a current value, at which the measured capacity was 96% or lower with respect to the initial capacity, and setting a current value before the calculated current value as a limit current value.

### <Additive: Added>

First, the initial capacity was measured. Next, the battery was discharged for 10 minutes, was charged at 55 A for 5 seconds, was discharged for 10 minutes, and was discharged at 55 A for 5 seconds. Next, the capacity was measured. Next, the battery was discharged for 10 minutes, was charged at 60 A for 5 seconds, was discharged for 10 minutes, and was discharged at 60 A for 5 seconds. Next, the capacity was measured, and then the charging-discharging current was increased at intervals of 5 A. These operations were repeated until the measured capacity reached 96% or lower with respect to the initial capacity (limit value: 90 A). The durability test was performed 30 times for each of the examples.

### <Additive: Not Added>

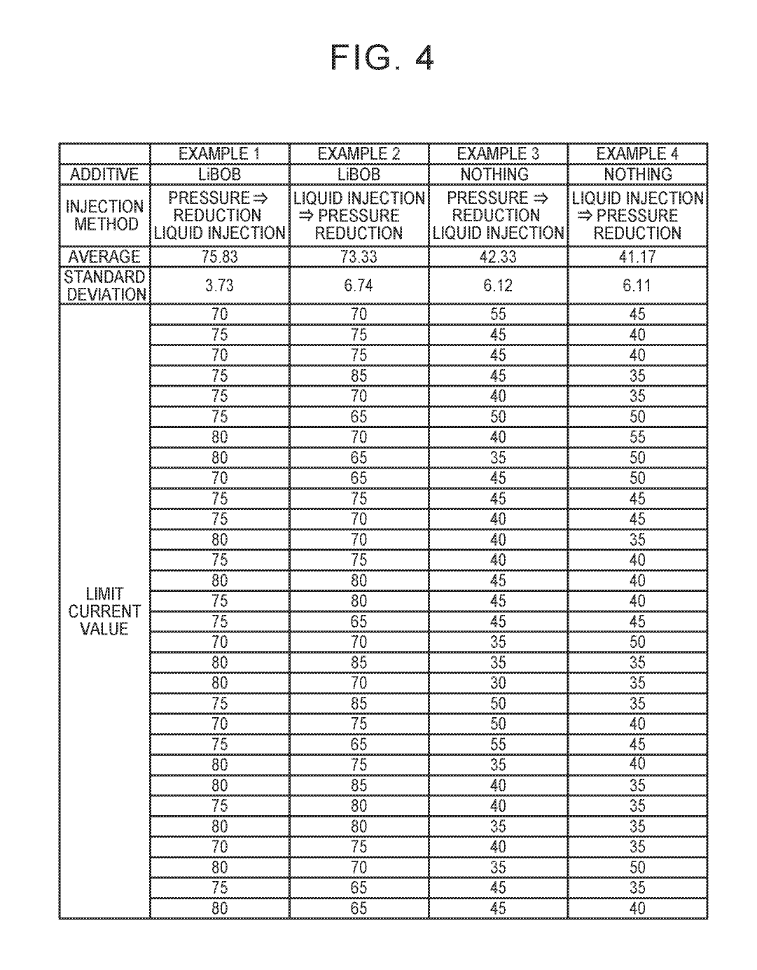

First, the initial capacity was measured. Next, the battery was discharged for 10 minutes, was charged at 20 A for 5 seconds, was discharged for 10 minutes, and was discharged at 20 A for 5 seconds. Next, the capacity was measured. Next, the battery was discharged for 10 minutes, was charged at 25 A for 5 seconds, was discharged for 10 minutes, and was discharged at 25 A for 5 seconds. Next, the capacity was measured, and then the charging-discharging current was increased at intervals of 5 A. These operations were repeated until the measured capacity reached 96% or lower with respect to the initial capacity (limit value: 60 A). The durability test was performed 30 times for each of the examples. Table 1 of FIG. 4 shows the results (limit current values) of the durability test according to each of the examples.

As shown in Table 1 of FIG. 4, in Example 1 in which the nonaqueous electrolytic solution was injected after the reduction in the internal pressure of the battery case and in which LiBOB was used as an additive, a standard deviation of the electrolytic current value is lower, and a variation in battery characteristics was improved, as compared to Examples 2 and 4 in which the internal pressure of the battery case was reduced after the injection of the nonaqueous electrolytic solution. The reason for this is presumed to be as follows: since the nonaqueous electrolytic solution was injected after the reduction in the internal pressure of the battery case, the nonaqueous electrolytic solution was able to spread over the entire region of the electrode body. Thus, it is presumed that the resistance value at the center of the electrode body was able to be increased, and battery characteristics were able to be stabilized. Even in the lithium ion secondary battery 100 in which SBR was used as the binder of the negative electrode and LiBOB was added to the nonaqueous electrolytic solution, a variation in resistance value was able to be reduced. In Example 3, the nonaqueous electrolytic solution was injected after the reduction in the internal pressure of the battery case, but no additives were added. In Example 3, an increase in standard deviation was found. Next, the durability test was performed using the same method as described above after defining the full width at half maximum β of a diffraction peak of a (003) plane obtained from the X-ray diffraction of the positive electrode active material.

### Example 5

A square battery was constructed using the same method as in Example 1, except that the full width at half maximum β of a diffraction peak of a (003) plane of the positive electrode active material was set as 0.048.

### Example 6

A square battery was constructed using the same method as in Example 1, except that the full width at half maximum β of a diffraction peak of a (003) plane of the positive electrode active material was set as 0.055.

### Example 7

A square battery was constructed using the same method as in Example 1, except that the full width at half maximum β of a diffraction peak of a (003) plane of the positive electrode active material was set as 0.086.

### Example 8

A square battery was constructed using the same method as in Example 1, except that the full width at half maximum β of a diffraction peak of a (003) plane of the positive electrode active material was set as 0.097.

### Example 9

A square battery was constructed using the same method as in Example 1, except that the full width at half maximum β of a diffraction peak of a (003) plane of the positive electrode active material was set as 0.114.

### Example 10

A square battery was constructed using the same method as in Example 1, except that the full width at half maximum β of a diffraction peak of a (003) plane of the positive electrode active material was set as 0.125.

### [Conditioning Treatment]

As in the case of the battery cells according to Examples 1 to 4, the state of charge (SOC) of each of the battery cells according to Examples 5 to 10 was adjusted to 80%, and the battery cell was stored at an environmental temperature of 60° C. for 3 days.

### [Durability Test]

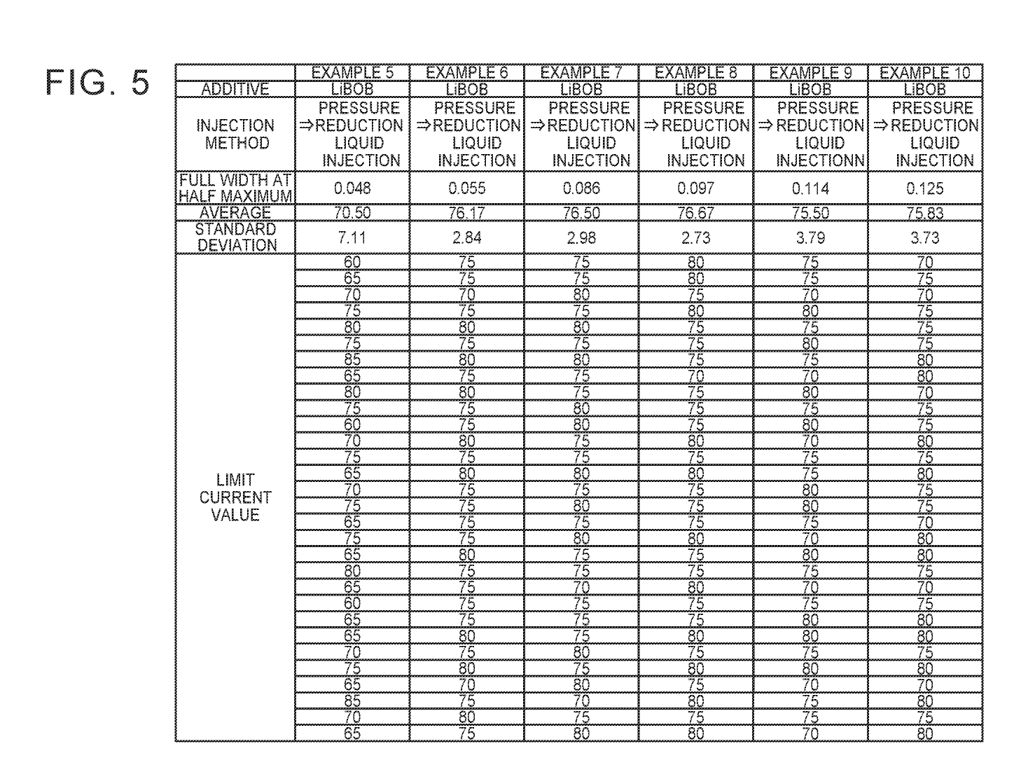

The durability test was performed on each of the battery cells according to the examples using the same method as in Example 1. Table 2 of FIG. 5 shows the results (limit current values) of the durability test according to each of the examples.

As shown in Table 2 of FIG. 5, in Examples 6 to 8 in which the full width at half maximum β satisfied 0.055≦β≦0.097, the standard deviation of the electrolytic current value was low (3 or lower), and a variation in battery characteristics was improved, as compared to the other examples. It is presumed that, in Examples 9 and 10 in which the full width at half maximum β was high, battery characteristics varied due to excessively high crystallinity. The reason for this is presumed to be that, the conductivity of the positive electrode active material is reduced due to high crystallinity, and contact between a conductive material and the positive electrode active material is not likely to occur. It is presumed that, in Example 5 in which the full width at half maximum β was low, battery characteristics varied due to excessively low crystallinity. The reason for this is presumed as follows: crystallinity was low, the layered structure was disordered, and thus metal was easily eluted from the positive electrode. As a result, the metal eluted from the positive electrode was deposited on the negative electrode, and thus the resistance was locally increased.

Hereinabove, the invention has been described in detail, but the above-described embodiments and examples are merely exemplary. The invention disclosed herein includes various modifications and alternations of the above-described specific examples.

What is claimed is:

1. A method of manufacturing a lithium ion secondary battery in which a battery system contains sodium,
the lithium ion secondary battery including a battery case which accommodates an electrode body and a nonaqueous electrolytic solution,
the electrode body including a positive electrode and a negative electrode,
the positive electrode including a positive electrode active material layer containing a positive electrode active material,
the negative electrode including a negative electrode active material layer containing a negative electrode active material,
the nonaqueous electrolytic solution containing lithium bis(oxalato)borate, and
the method comprising:
reducing an internal pressure of the battery case; and
injecting the nonaqueous electrolytic solution after reduction in the internal pressure.

2. The method according to claim 1, wherein
the negative electrode contains styrene-butadiene rubber as a binder.

3. The method according to claim 1, wherein
in the positive electrode active material, a full width at half maximum β of a diffraction peak of a (003) plane satisfies 0.055≦β≦0.097.

4. The method according to claim 1, wherein
during reduction in the internal pressure, a vacuum degree is 1 kPa·abs to 10 kPa·abs.
